(19) United States
(12) Patent Application Publication
(10) Pub. No.: US 2004/0168868 A1
(43) Pub. Date: Sep. 2, 2004

(54) Disc brake pad backplate assembly

(76) Inventor: Paul Anthony Thomas, Newport (GB)

Correspondence Address: CARLSON, GASKEY & OLDS, P.C., 400 WEST MAPLE ROAD, SUITE 350, BIRMINGHAM, MI, 48009, US

(21) Appl. No.: 10/763,955

(22) Filed: Jan. 23, 2004

(30) Foreign Application Priority Data
Jan. 25, 2003 (GB) 0301799.3

(51) Int. Cl. F16D 55/00

(52) U.S. Cl. 188/73.37; 188/73.31

(57) ABSTRACT

A disc brake pad backplate assembly includes a backplate and a pad spring. The backplate and/or the pad spring includes a retaining feature to mount the pad spring to the backplate and circumferentially spaced abutments arranged to restrain lateral movement of the end portions of the pad spring. The pad spring is dimensioned relative to the spacing of the abutments such that a radially inward loading applied at a central portion of the pad spring causes the pad spring to function in a first resilient leaf spring-like mode in which the pad spring end portions are unrestrained up to a predetermined load limit. Above the predetermined load limit, the end portions are restrained by the abutments such that the pad spring functions in a second buckling mode. The spring rate is relatively low in the first mode and relatively high in the second mode.

This application claims priority to United Kingdom Patent Application GB 0301799.3 filed on Jan. 25, 2003.

### BACKGROUND OF THE INVENTION

The present invention relates to a disc brake pad backplate assembly including a backplate and a pad spring.

Known disc brakes 10 (shown in FIGS. 1 to 3) include a disc or rotor 20 mounted to a wheel hub for rotation with a vehicle wheel. A brake carrier 12 is fixed relative to the axis of rotation of the rotor 20 and is secured to a non-rotating portion of the vehicle (e.g. the vehicle suspension). In “floating caliper” type brakes, a brake caliper 15 including a bridge 16 secured to a housing 14 is slidably mounted on the carrier 12 to allow for movement parallel to the axis of rotation of the rotor 20. An actuator 18 communicates with one or more pistons or tappets (not shown) provided in the housing 14 to apply the force required for the brake to function.

A pair of brake pads 22 including friction material 36 mounted to a solid backplate 34 are positioned on either side of the rotor 20. The friction material 36 faces the planar faces of the rotor 20. The backplates 34 of the brake pads 22 are seated on vertical and horizontal abutment regions 28 and 30, respectively, provided in openings 32 in the carrier 12 to restrain the brake pads 22 from rotational and radially inward movement, respectively. In a typical “floating caliper” type brake, one of the backplates 34 engages with the piston(s), either directly or via a spreader plate, to distribute the load. The actuator 18 causes the piston to push one of the brake pads 22 toward the rotor 20 to achieve braking. Because the caliper is able to “float” on the carrier 12, an equal frictional braking load is applied by both brake pads 22.

The backplates 34 of the vehicle disc brake pads 22 perform two functions. First, the brake pads 22 provide a solid support for slidably mounting the friction material 36 of the brake within the brake carrier 12 to transmit the shear loads induced on the friction material 36 during braking to the carrier 12. Second, the brake pads 22 transmit and evenly distribute the pressure applied by the brake tappets or the pistons during braking to the surface of the friction material 36 to ensure even wear of the friction material 36. To perform the functions, resilient members (such as a leaf type pad springs 24) are commonly used to restrain radially outward movement of the brake pads 22 in the carrier 12 while permitting movement towards and away from an associated brake disc and to prevent rattling of the brake pad 22 in use.

The pad springs 24 are typically elongate and, when fitted, extend along a portion of the radially outermost face of the backplate 34. The pad springs 24 are typically pre-loaded to a certain extent against the carrier 12 by a pad strap 26, which spans an opening between the bridge 16 and the housing 14 and contacts the approximate center of the pad spring 24. This force is typically reacted radially outwardly by contact of the backplate 34 with each end of the pad spring 24. Formations are also typically provided on the backplate 34 and/or the pad spring 24 to retain the pad spring 24 on the backplate 34 during movement of the brake pad 22 parallel to the axis of rotation of the rotor 14.

FIG. 3 illustrates a prior art backplate 34 and pad spring 24 disclosed in EP 0248385 (Lucas Industries PLC). The backplate 34 includes circumferentially inward facing abutment portions 40 on the radially outer face that retain inwardly curved ends 42 of the pad spring 24. The pad spring 24 is held down by a pad strap 26 positioned at a central portion 48 of the pad spring 24. Radially inward projecting ears 46 located between the ends 42 and the central portion 48 of the pad spring 24 retain the pad spring 24 on the backplate 34 during sliding of the backplate 34 toward and away from the rotor 20. Because the pad spring 24 is restrained at its ends 42, radially inward deflection of the central portion 48 only occurs as a result of elastic buckling of the pad spring 24 (i.e., portions of the pad spring 24 intermediate the ends 42 and the central portion 48 must deflect radially outwardly as the center portion 48 deflects radially inwardly). Therefore, the pad spring 24 has a high spring rate (a high load per unit deflection of the central portion 48 of the pad spring 24 radially inwardly). This is advantageous because the tendency of the backplate 12 to rattle within the carrier is reduced, reducing noise and wear. However, the force required to slide the backplate 34 toward the brake disc is increased, requiring a relatively high load to slide the backplate 34 towards the rotor 20 and an increased load to slide the caliper relative to the carrier 12.

PCT publication WO 92/00465 (Knorr-Bremse) discloses a backplate assembly including a pad spring with circumferentially unrestrained ends. Under load, the center of the pad spring abuts the radially outer face of the backplate before the circumferentially inner edges of the securement apertures abut the securement lugs. The raised portions proximate each end of the pad spring fail to restrain the curved ends of the pad spring because of their respective shapes and the spacing therebetween. This arrangement reduces the slide load, but increases the generation of noise and wear due to increased rattling of the assembly in use.

### SUMMARY OF THE INVENTION

The present invention seeks to overcome, or at least mitigate, the problems of the prior art.

The present invention provides a disc brake pad backplate assembly including a backplate and pad spring. The backplate and/or pad spring includes a retaining member to mount the pad spring to the backplate and circumferentially spaced abutments arranged to restrain lateral movement of end portions of the pad spring. The pad spring is dimensioned relative to the spacing of the abutments so that a radially inward loading applied at a central portion of the pad spring causes the spring to function in a first resilient leaf spring-like mode in which the pad spring end portions are unrestrained up to a predetermined load limit. Above the predetermined load limit, the end portions are restrained by the abutments so that the pad spring functions in a second buckling mode. The spring rate is relatively low in the first mode and relatively high in the second mode.

These and other features of the present invention will be best understood from the following specification and drawings.

### BRIEF DESCRIPTION OF THE DRAWINGS

Embodiments of the present invention will now be described, by way of example only, with reference to the accompanying drawings in which:

FIG. 1 is a plan view of a disc brake incorporating a prior art disc brake pad backplate assembly;

FIG. 2 is an end view of the disc brake of FIG. 1;

FIG. 3 is an elevational view of a portion of the carrier and one prior art disc pad and pad spring of FIGS. 1 and 2;

FIG. 4 is a plan view of a backplate assembly according to embodiment of the present invention;

FIG. 5 is a cross-sectional view of FIG. 4 along the axis X-X;

FIG. 5A is a cross-sectional view of the circled portion of FIG. 5 showing one end of the pad spring abutting its corresponding abutment; and

FIG. 6 is a graph illustrating the load-deflection characteristics of the backplate assembly of the present invention in comparison with prior art backplate assemblies.

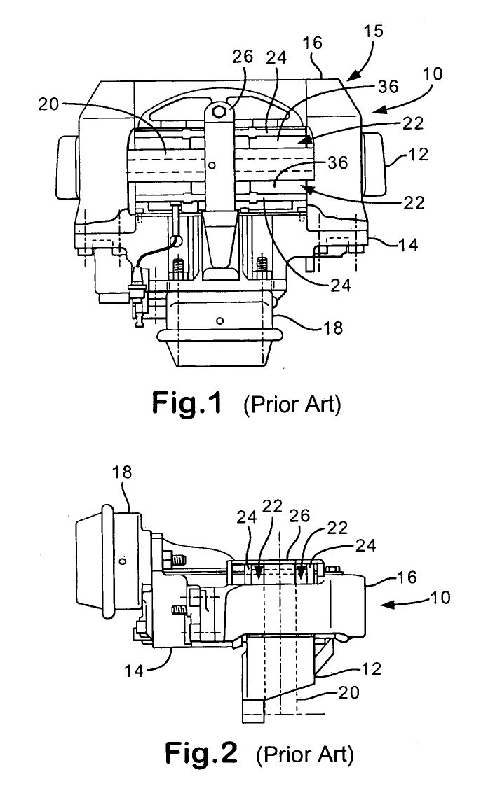

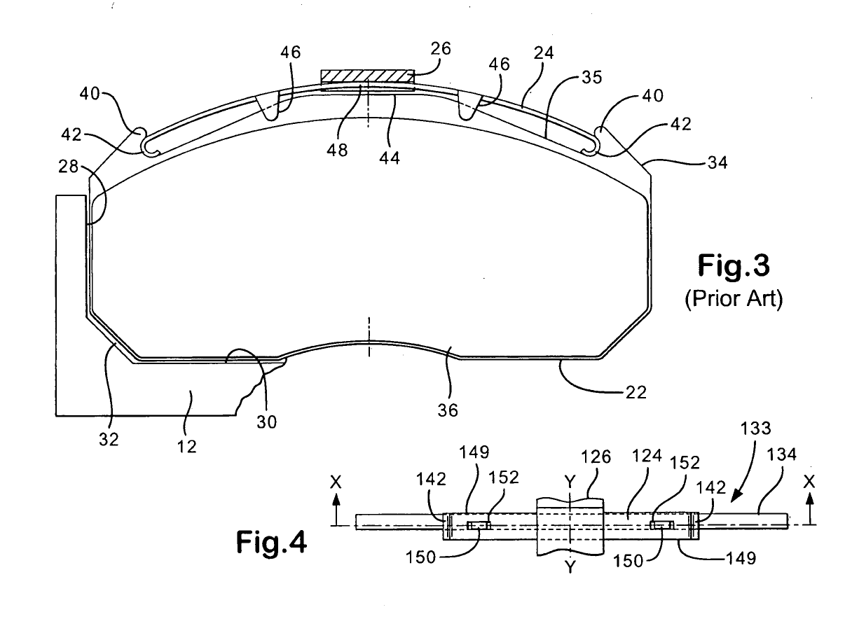

### DETAILED DESCRIPTION OF THE PREFERRED EMBODIMENT

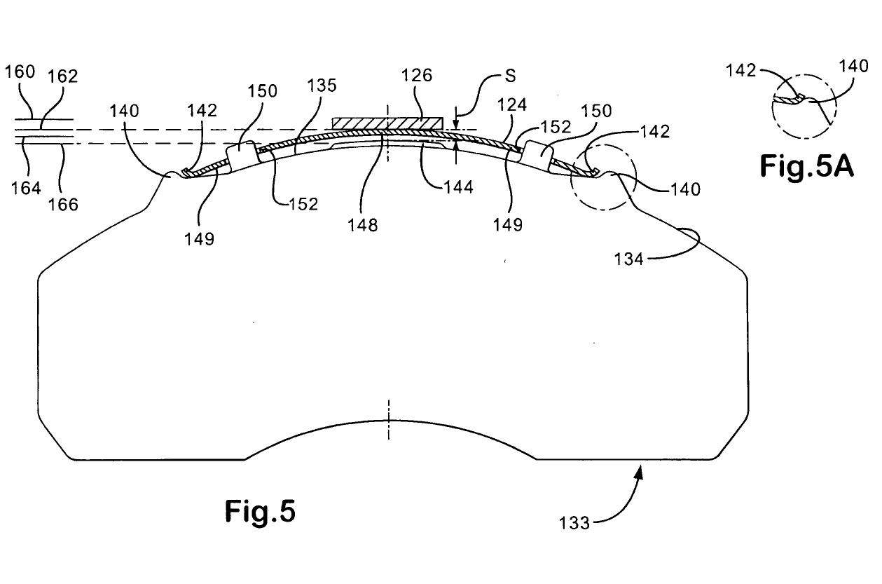

FIGS. 4 and 5 illustrate the disc brake pad backplate assembly 133 according to one embodiment of the present invention. The disc brake pad backplate assembly 133 is capable of being fitted into the prior art disc brake 10 described above. The disc brake pad backplate assembly 133 includes a backplate 134 to which friction material (not shown) is secured. The backplate 134 includes a pair of circumferentially spaced abutments 140 on a radially outer face 135. Pad spring retaining features, such as a pair of radially outwardly extending lugs 150, also project from the radially outer face 135 of the backplate 134 and are located between abutments 140.

As shown in FIG. 4, a pad spring 124 is fitted to the backplate 134. The pad spring 124 is elongate and has a central region 148 and end regions 149. When fitted to the backplate 134, the pad spring 124 extends in the circumferential direction transverse to the axis of movement Y-Y of the backplate 134 towards and away from the rotor 20 when in use. The pad spring 124 includes upturned ends 142 and two of slots 152 in the end regions 149 that the lugs 150 fit through. The abutments 140 on backplate 134 are shaped to prevent the upturned ends 142 of the pad spring 124 from sliding over them. A pad strap 126 retains the central portion 148 of the pad spring 124.

Prior to fitting the pad spring 124 onto the lugs 150, the pad spring 124 has an arcuate profile with a shorter radius of curvature than shown in FIG. 5. To fit the pad spring 124 to the backplate 134, the pad spring 124 must be compressed by a certain amount for the slots 152 to fit over both the lugs 150. Once fitted, a certain amount of relaxation occurs and the circumferentially outermost edge of the slots 152 contact the radially outermost face of the lugs 150, retaining the pad spring 124 on the backplate 134 before the disc brake pad backplate assembly 133 is mounted in the brake 10. In other embodiments, the lugs 150 may not perform this circumferential retaining function. The height of the central portion 148 of the pad spring 124 when fitted is represented by the line 160.

In FIG. 5, the disc brake pad backplate assembly 133 is shown in its assembled state on the disc brake 10 with the pad strap 126 in place. The pad strap 126 depresses the central portion 148 of the pad spring 124 such that the circumferentially outermost edges of the slots 152 no longer contact the lugs 150, creating a space between the circumferentially innermost edges of holes 152 and the lugs 150. This assembled state corresponds to the line 162 in which there is a distance S between the pad strap 126 and the outer face 135 of the backplate 134.

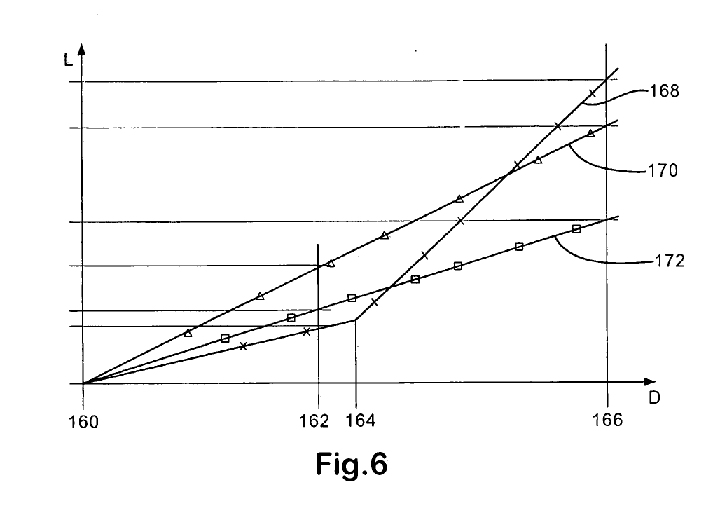

Referring to FIG. 6, the load-deflection characteristics of the pad spring 124 are shown as the line 168, the load-deflection characteristics of a pad spring with restrained ends (e.g., the assembly of EP 0248385) are shown by the line 170, and the characteristics of a pad spring with unrestrained ends (e.g., the assembly of WO 92/00465) are illustrated by the line 172. The load and deflection of each spring, when fitted to their respective backplate, but not assembled in the brake (i.e., at line 160) are taken as the datum point. From zero load and deflection position 160 up until the assembled deflection 162, the spring rate of the spring 124 is relatively low.

When the backplate 134 is subjected to radially outward accelerative loads (for example, when a vehicle is travelling over uneven terrain), the loads cause the distance S between the strap 126 and the central region 144 of the backplate 134 to decrease. This causes the spring 124 to straighten along its length, and the ends 142 to slide circumferentially outwardly upwardly until the ends 142 contact the abutments 140. This constitutes a first “leaf spring” mode of operation of the pad spring 124, similar to the mode of operation of the prior art backplate assembly disclosed in WO 92/00465. At this point, deflection 164 is reached.

Further deflections towards the radially outermost face 135 of the backplate 134 up to the position 166 have a significantly higher spring rate due to the pad spring 124 entering a second elastic “buckling” mode of deflection in which the central portion 148 continues to straighten, but the portions intermediate the central portion 148 and the ends 142 are forced to curve away from the radially outer face 135.

Operation using the above two modes provides for a low slide load of the backplate 134 against the carrier and of the caliper relative to the carrier under normal operation, but increased loads to minimize rattling when the backplate 134 is subjected to high radial accelerations, minimizing noise and wear of both the backplate 134 and the abutment portions 28 and 30 of the carrier 12. Prior springs have an increased sliding force requirement at the fitted deflection 162 (line 170) and have a low spring rate at more extreme deflections that in turn may lead to increased wear and noise (line 172).

It should be understood that numerous changes may be made within the scope of the present invention. For example, alternative features of securing the pad spring to the backplate may be employed, as may other suitable shapes of the pad spring end and abutment (e.g., such as inwardly curved or straight ends). The circumferential restraint need not occur at the extreme ends of the spring. For example the abutments for providing circumferential restraint may be the circumferential inner faces of the lugs which restrain the circumferentially inner edges of the slots. The change over from the first to the second mode may be varied by altering the length of the spring relative to the spacing of the abutments.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A disc brake pad backplate assembly comprising:
a backplate including circumferentially spaced abutments separated by a distance;
a pad spring including end portions and a central portion between the end portions, wherein the circumferentially spaced abutments of the backplate restrain lateral movement of the end portions of the pad spring; and
a retaining feature to mount the pad spring to the backplate, wherein at least one of the backplate and the pad spring includes the retaining feature,
wherein the pad spring is dimensioned relative to the distance between the circumferentially spaced abutments such that a radially inward loading applied at the central portion of the pad spring causes the pad spring to function in a first resilient leaf spring-like mode where the end portions of the pad spring are unrestrained up to a predetermined load limit, and wherein above the predetermined load limit the end portions of the pad spring are restrained by the circumferentially spaced abutments of the backplate and the pad spring functions in a second buckling mode, and
wherein a spring rate of the pad spring in the first mode is lower than the spring rate of the pad spring in the second mode.

2. The backplate assembly according to claim 1 wherein the pad spring further includes radially outwardly curved ends.

3. The backplate assembly according to claim 2 wherein the backplate further includes complementary curved abutment surfaces.

4. The backplate assembly according to claim 1 wherein the retaining feature is lugs.

5. The backplate assembly according to claim 4 wherein the backplate includes the lugs, and the lugs extend radially outwardly from the backplate.

6. The backplate assembly according to claim 4 wherein the backplate includes the lugs and the pad spring further includes complementary apertures that receive the lugs.

7. The backplate assembly according to claim 6 wherein the lugs are the circumferentially spaced abutments.

8. The backplate assembly according to claim 1 wherein the pad spring has a curved profile.

9. The backplate according to claim 8 further including a pad strap, wherein the pad spring is retained by the pad strap.

10. A disc brake comprising:
a backplate assembly including a backplate including circumferentially spaced abutments separated by a distance;
a pad spring including end portions and a central portion between the end portions, wherein the circumferentially spaced abutments of the backplate restrain lateral movement of the end portions of the pad spring; and
a retaining feature to mount the pad spring to the backplate, wherein at least one of the backplate and the pad spring includes the retaining feature,
wherein the pad spring is dimensioned relative to the distance between the circumferentially spaced abutments such that a radially inward loading applied at the central portion of the pad spring causes the pad spring to function in a first resilient leaf spring-like mode where the end portions of the pad spring are unrestrained up to a predetermined load limit, and wherein above the predetermined load limit the end portions of the pad spring are restrained by the circumferentially spaced abutments of the backplate and the pad spring functions in a second buckling mode, and
wherein a spring rate of the pad spring in the first mode is lower than the spring rate of the pad spring in the second mode.

11. A vehicle comprising;
a disc brake including a backplate assembly including a backplate including circumferentially spaced abutments separated by a distance;
a pad spring including end portions and a central portion between the end portions, wherein the circumferentially spaced abutments of the backplate restrain lateral movement of the end portions of the pad spring; and
a retaining feature to mount the pad spring to the backplate, wherein at least one of the backplate and the pad spring includes the retaining feature,
wherein the pad spring is dimensioned relative to the distance between the circumferentially spaced abutments such that a radially inward loading applied at the central portion of the pad spring causes the pad spring to function in a first resilient leaf spring-like mode where the end portions of the pad spring are unrestrained up to a predetermined load limit, and wherein above the predetermined load limit the end portions of the pad spring are restrained by the circumferentially spaced abutments of the backplate and the pad spring functions in a second buckling mode, and
wherein a spring rate of the pad spring in the first mode is lower than the spring rate of the pad spring in the second mode.
